(19) United States
(12) Patent Application Publication
(10) Pub. No.: US 2009/0244770 A1
(43) Pub. Date: Oct. 1, 2009

(54) MANUFACTURING METHOD OF MAGNETIC RECORDING MEDIUM, THE MAGNETIC RECORDING MEDIUM, AND MAGNETIC RECORDING APPARATUS

(75) Inventors: Jun Taguchi, Kawasaki (JP); Ryo Kurita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/250,355

(22) Filed: Oct. 13, 2008

(30) Foreign Application Priority Data
Mar. 26, 2008 (JP) 2008-080738

(51) Int. Cl. G11B 5/127; B05D 5/00; G11B 5/62

(52) U.S. Cl. 360/110; 427/131; 428/800; G9B/5.233; G9B/5.04

(57) ABSTRACT

Aspects of the present embodiments are related to manufacturing methods of magnetic recording media. The manufacturing method of a magnetic recording medium includes a step of stacking a soft magnetic backing layer, an intermediate layer, a first recording layer having a perpendicular magnetic anisotropy, an exchange coupling force control layer including ruthenium, and a second recording layer having a perpendicular magnetic anisotropy on a substrate in order. A gas pressure of a process gas when the exchange coupling force control layer is being formed is higher than the gas pressure of the process gas when being normally used.

### BACKGROUND OF THE INVENTION

1. Field of the Invention

The present invention generally relates to manufacturing methods of magnetic recording media, the magnetic recording media, and magnetic recording apparatuses. More specifically, the present invention relates to a magnetic recording medium which is appropriate for perpendicular magnetic recording, a manufacturing method of the magnetic recording medium, and a magnetic recording apparatus.

2. Description of the Related Art

As the information society is improving, higher recording densities are required for a magnetic recording medium installed in a magnetic recording apparatus which is a main part of an information recording apparatus. For example, the recording density of hard disk is being improved at 50% or more per year in the field of hard disk drives (HDD). In order to realize such high recording densities, a perpendicular magnetic recording medium where magnetization of the recording layer is in a perpendicular direction is more effective than a longitudinal recording medium where magnetization of the recording layer is in a longitudinal direction. In the perpendicular magnetic recording medium, since magnetization directions of neighboring bits of the recording layer are antiparallel to each other so as to be mutually strengthened, it is possible to easily realize the high recording densities.

However, if the recording density is high, an area of a domain containing one bit of magnetic information is reduced so that the strength of magnetization in the domain is weakened. Hence, a problem of “heat fluctuation” occurs where the magnetization is reversed due to heat so that the magnetic information disappears. In order to solve the problem of heat fluctuation, a material having high magnetic anisotropic energy may be used. On the other hand, if the magnetic anisotropic energy is high, a recording magnetic field for writing the magnetic recording information becomes strong so that writing ease of the recording layer is reduced.

Thus, heat fluctuation resistance and the writing ease are in trade-off with each other. Therefore, it is important for improvement of the perpendicular magnetic recording medium to achieve both the heat fluctuation resistance and the writing ease.

In order to achieve both the heat fluctuation resistance and the writing ease, an exchange coupled composite (ECC) magnetic recording medium has been suggested in Japanese Laid-Open Patent Application Publication No. 2005-56555. In the ECC magnetic recording medium, two recording layers having magnetization easy axes perpendicular or longitudinal to a substrate or in oblique directions to each other are stacked. An exchange coupling force control layer which is non-magnetic or high-saturation magnetic is inserted as an intermediate layer between the recording layers, so that exchange coupling energy between the recording layers is controlled and the recording magnetic field is reduced. In Japanese Laid-Open Patent Application Publication No. 2005-56555, a ruthenium (Ru) layer is described as the non-magnetic exchange coupling force control layer, and a cobalt (Co) layer is described as the high-saturation magnetic exchange coupling force control layer. Especially, it is preferable to use ruthenium (Ru), which has good lattice matching with the recording layer, as a material of the exchange coupling force control layer.

However, in a case where only ruthenium (Ru) is used as the non-magnetic exchange coupling force control layer, if the exchange coupling force control layer is too thick, the exchange coupling energy of the upper and lower recording layers becomes small. As a result of this, even if magnetization of one of the recording layers is reversed due to the recording magnetic field, magnetization of another recording layer is not reversed so that it is necessary to strengthen the recording magnetic field in order to write the magnetic information. Because of this, in a case where the non-magnetic exchange coupling force control layer is formed in the ECC magnetic recording medium, it is necessary to make the exchange coupling force control layer have a thickness equal to or smaller than 0.2 nm. However, it is extremely difficult to control the film thickness of the exchange coupling force control layer so as to make the exchange coupling force control layer extremely thin. Thus, there is a problem of producability of the magnetic recording medium.

### SUMMARY OF THE INVENTION

Accordingly, embodiments of the present invention may provide a novel and useful manufacturing method of a magnetic recording medium, the magnetic recording medium, and a magnetic recording apparatus solving one or more of the problems discussed above.

More specifically, the embodiments of the present invention may provide a manufacturing method of a magnetic recording medium whereby producability of the magnetic recording medium can be improved even if a layer made of only ruthenium (Ru) is used as a material of an exchange coupling force control layer, the magnetic recording medium, and a magnetic recording apparatus.

One aspect of the present invention may be to provide a manufacturing method of a magnetic recording medium, including a step of stacking a soft magnetic backing layer, an intermediate layer, a first recording layer having a perpendicular magnetic anisotropy, an exchange coupling force control layer including ruthenium, and a second recording layer having a perpendicular magnetic anisotropy on a substrate in order, wherein a gas pressure of a process gas when the exchange coupling force control layer is being formed is higher than the gas pressure of the process gas when being normally used.

Another aspect of the present invention may be to provide a manufacturing method of a magnetic recording medium, including a step of stacking a soft magnetic backing layer, an intermediate layer, a first recording layer having a perpendicular magnetic anisotropy, an exchange coupling force control layer including ruthenium, and a second recording layer having a perpendicular magnetic anisotropy on a non-magnetic substrate in order, wherein a gas pressure of a process gas when the exchange coupling force control layer is being formed is equal to or greater than 2 Pa and equal to or less than 5 Pa.

Other aspect of the present invention may be to provide a magnetic recording medium including a substrate; a soft magnetic backing layer formed on the substrate; an intermediate layer formed on the soft magnetic backing layer; a first recording layer having a perpendicular magnetic anisotropy, the first recording layer being formed on the intermediate layer; an exchange coupling force control layer formed on the first recording layer, the exchange coupling force control layer including ruthenium, the exchange coupling force control layer having a film thickness equal to or greater than 0.2 nm and equal to or less than 0.4 nm; and a second recording layer formed on the exchange coupling force control layer, the second recording layer having a perpendicular magnetic anisotropy, the second recording layer ferromagnetically coupled to the first recording layer via the exchange coupling force control layer.

Other aspect of the present invention may be to provide a magnetic recording apparatus, including the above-mentioned magnetic recording medium; and a magnetic head facing the magnetic recording medium.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic cross-sectional view of a magnetic recording medium of an embodiment of the present invention;

FIG. 2 is a graph showing a relationship between film thickness of an exchange coupling force control layer and a reversal magnetic field;

FIG. 3 is a graph showing a relationship between argon (Ar) gas pressure and ruthenium (Ru) film thickness; and

FIG. 4 is a plan view of a magnetic recording and reproducing apparatus of the embodiment of the present invention.

### DETAILED DESCRIPTION OF THE PREFERRED EMBODIMENTS

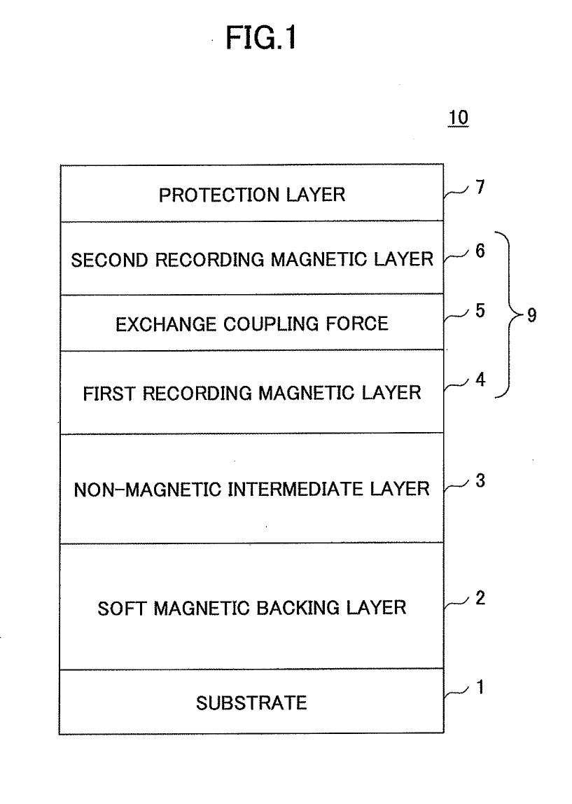

A description is given below, with reference to FIG. 1 through FIG. 4 of embodiments of the present invention.

FIG. 1 is a schematic cross-sectional view of a perpendicular magnetic recording medium 10 having an exchange coupled composite (ECC) structure of an embodiment of the present invention. As shown in FIG. 1, in the perpendicular magnetic recording medium 10 having the ECC structure, a soft magnetic backing layer 2, a non-magnetic intermediate layer 3, a magnetic recording layer 9, and a protection layer 7 are stacked on a substrate 1.

The substrate 1 is a non-magnetic substrate made of a non-magnetic material such as glass, aluminum (Al), or silicon (Si). The soft magnetic backing layer 2 stacked on an upper part of the substrate 1 is made of a FeCo alloy which has a high magnetic permeability and which is amorphous. The magnetic backing layer 2 may have a structure where plural layers including the non-magnetic layer are stacked. For example, the magnetic backing layer 2 may be formed by stacking each of a FeCoB layer, an Ru layer, and a FeCoB layer.

The non-magnetic intermediate layer 3 urges perpendicular orientation of a magnetization easy axis of the magnetic recording layer 9 so that crystallinity is improved. The non-magnetic intermediate layer 3 may be formed of a single layer or plural layers. In this embodiment, ruthenium (Ru) having good lattice matching with the magnetic recording layer 9 is used for the non-magnetic intermediate layer 3. However, the non-magnetic intermediate layer 3 can be formed by stacking, for example, an amorphous Ta layer, a NiFeCr layer, and an Ru layer or a NiFeCr layer and an Ru layer.

The magnetic recording layer 9 is formed by connecting a first recording magnetic layer 4 and a second recording magnetic layer 6 to each other with an exchange coupling control layer 5. The first recording magnetic layer 4 is a magnetic layer having a high magnetic anisotropy (high Hk). A granulite material where SiO₂ is added to CoCrPt alloy is used and a Pt composition amount is equal to or greater than 20 at % so that high Hk of the first recording magnetic layer 4 is achieved. In addition, the second recording magnetic layer 6 is a magnetic layer having a magnetic anisotropy (low Hk) lower than that of the first recording magnetic layer 4. A granulite material where SiO₂ is added to a CoCrPt alloy is used and a Pt composition amount is equal to or greater than 15 at % so that the magnetic anisotropy (Hk) of the second recording magnetic layer 6 is lower than that of the first recording magnetic layer 4.

In the embodiment of the present invention, the second recording magnetic layer 6 is stacked on the first recording magnetic layer 4 as a lower layer via the exchange coupling force control layer 5. However, a high Hk recording magnetic layer may be stacked on a low Hk recording magnetic layer as a lower layer via the exchange coupling force control layer 5.

The exchange coupling force control layer 5 is configured to realize a good ECC structure. In this embodiment, only ruthenium (pure Ru) is used for the exchange coupling force control layer 5. As discussed below, the exchange coupling force control layer 5 is formed by using a gas pressure higher than a process gas pressure normally used.

As the protection layer 7, for example, a diamond-like carbon (DLC) layer may be used. A lubricant agent may be applied on the protection layer 7.

Next, manufacturing processes of the magnetic recording medium 10 of the embodiment of the present invention are discussed.

In order to manufacture the magnetic recording medium 10, first, an approximately 50 nm through approximately 100 nm, preferably approximately 50 nm, CoNbZr layer is formed on the non-magnetic substrate 1 such as a glass substrate by a sputtering method as the soft magnetic backing layer 2. In this sputtering method, the temperature of the substrate is kept at room temperature, Ar gas is used as the process gas (sputtering gas), and deposition pressure is approximately 0.5 Pa.

The substrate 1 is not limited to a glass substrate. As the substrate 1, for example, an Al alloy substrate, a silicon substrate having a surface where a thermal oxidation film is formed, or a plastic substrate can be used. In addition, the magnetic backing layer 2 is not limited to a single layer structure. The soft magnetic backing layer 2 may be separated into two layers by the non-magnetic layer 3 such as an Ru layer and the separated soft magnetic layers 2 may be antiferromagnetically coupled, so as to prevent a leakage magnetic field causing spike noise from coming out of from the soft magnetic backing layer 2.

Next, by a sputtering method using Ar gas as the process gas, a Ru layer having thickness of approximately 2 nm through approximately 30 nm is formed on the soft magnetic backing layer 3 under the condition of approximately 0.5 Pa deposition pressure so that the non-magnetic intermediate layer 3 can be formed. When the non-magnetic intermediate layer 3 is formed, the substrate is kept at room temperature.

Next, a CoCrPt·SiO₂ layer, having a granulite structure where CoCrPt particles are dispread in silicon oxide (SiO₂) and having a thickness of approximately 10 nm, is formed by a sputtering method so that the first recording magnetic layer 4 is formed. At this time, by setting the Pt composition amount equal to or greater than 20 at % as discussed above, the first recording magnetic layer 1 has a high Hk. Although there is no limitation in deposition conditions of the first recording magnetic layer 4, Ar gas is used as the process gas and the deposition pressure is approximately 0.5 Pa in this embodiment.

Here, the non-magnetic intermediate layer 3 made of ruthenium, which is a lower layer of the first recording magnetic layer 4, has a hexagonal close-packed (hcp) crystal structure, so that the orientations of the CoCrPt particles in the first recording magnetic layer 4 are arranged in a perpendicular direction. As a result of this, the CoCrPt particles as well as the non-magnetic intermediate layer 3 have the hcp crystal structure extending in a perpendicular direction. The height direction of a hexagonal column having the hcp structure is a magnetization easy axis. The first recording magnetic layer 4 has perpendicular magnetic anisotropy.

As long as the first recording magnetic layer 4 has the perpendicular magnetic anisotropy, the first recording magnetic layer 4 is not limited to the granulite structure. For example, a CoCr group alloy layer having the perpendicular magnetic anisotropy may be formed as the first recording magnetic layer 4.

Next, a pure Ru layer (a layer made of only Ru) is formed, as the exchange coupling force control layer 5 made of an antiferromagnetic material, on the first recording magnetic layer 4 by a sputtering method. Sputtering of Ru is performed by using Ar gas as the process gas where the substrate is kept at room temperature. At this time, in this embodiment, the deposition gas pressure of the process gas is approximately 2 Pa and higher than the process gas pressure (0.5 Pa) normally used. In addition, in this embodiment, the thickness of the exchange coupling force control layer 5 is equal to or greater than 0.2 nm and equal to or less than 0.4 nm. Thus, in this embodiment, the exchange coupling force control layer 5 is thick. Hence, it is possible to improve deposition efficiency of the exchange coupling force control layer 5. Therefore, it is possible to improve producability of the perpendicular magnetic recording medium 10.

After forming the exchange coupling force control layer 5, the second recording magnetic layer 6 is formed on the exchange coupling force control layer 5. More specifically, by using the sputtering method using Ag gas as the process gas, a CoCrPt layer as the second recording magnetic layer 6 having thickness of approximately 6 nm is formed on the exchange coupling force control layer 5 under the condition of the deposition pressure of approximately 0.5 Pa. At this time, by making the Pt composition amount equal to or greater than 15 at %, the magnetic anisotropy of the formed second recording magnetic layer 6 as compared to the first recording magnetic layer 4 has a low Hk.

The second recording magnetic layer 6, as well as the first recording magnetic layer 4, has perpendicular magnetic anisotropy. The first recording magnetic layer 4 and the second magnetic recording layer 6 are ferromagnetically coupled with each other via the exchange coupling force control layer 5. Exchange coupling energy (magnetic anisotropic energy) between the first recording magnetic layer 4 and the second magnetic recording layer 6 can be controlled by the exchange coupling force control layer 5. The forming order of the first recording magnetic layer 4 and the second magnetic recording layer 6 is not limited to this embodiment and may be reversed compared to this embodiment.

Next, by a Radio Frequency Chemical Vapor Deposition (RF-CVD) method where C₂H₂ gas is used as the reaction gas, a diamond-like carbon layer having thickness of approximately 4 nm as the protection layer 7 is formed on the second recording magnetic layer 6. A lubricant agent may be applied on the protection layer 7. As a result of this, the magnetic recording medium 10 of the embodiment of the present invention is manufactured.

In the above-discussed manufacturing method of the perpendicular magnetic recording medium 10 of the embodiment of the present invention, the pure Ru layer is formed as the exchange coupling force control layer 5. Furthermore, when the exchange coupling force control layer 5 is formed by a sputtering method, the deposition gas pressure of the process gas (2 Pa) is set to be higher than the process gas pressure (0.5 Pa) normally used.

Hence, since the pure Ru is used as a material of the exchange coupling force control layer 5 and deposition is performed with a high process gas pressure, it is possible to expand the margin of the Ru film thickness. In other words, by using the pure Ru as the material of the exchange coupling force control layer 5, it is possible to improve the lattice matching of the second recording magnetic layer 6.

In addition, by depositing with the high process gas pressure, ruthenium (Ru) forming the exchange coupling force control layer 5 has a particle structure. The exchange coupling force control layer 5 acts with an effect called the Ruderman-Kittel-Kasuya-Yoshida (RKKY) interaction with the upper and lower magnetic layers so as to control the exchange coupling force. However, by the exchange coupling force control layer 5 having the particle structure, the action is weakened so that it is possible to make the exchange coupling force control layer 5 thick in order to strengthen the action.

Since the magnetic layer (the second recording magnetic layer 6) stacked on the exchange coupling force control layer 5 having the particle structure grows following the exchange coupling force control layer 5, the second recording magnetic layer 6 has a structure the same as or similar to the particle structure. In addition, in a case where the second recording magnetic layer 6 is made of a material having the particle structure, the particle structure of the second recording magnetic layer 6 is further promoted. As a result of this, since separation of magnetic coupling is promoted in the surface of the second recording magnetic layer 6, it is possible to improve the medium recording resolution of the second recording magnetic layer 6.

While the pure Ru is used in the embodiment of the present invention, the same effect can be achieved even if an alloy including ruthenium (Ru) is used as long as the lattice matching with the recording magnetic layer is good.

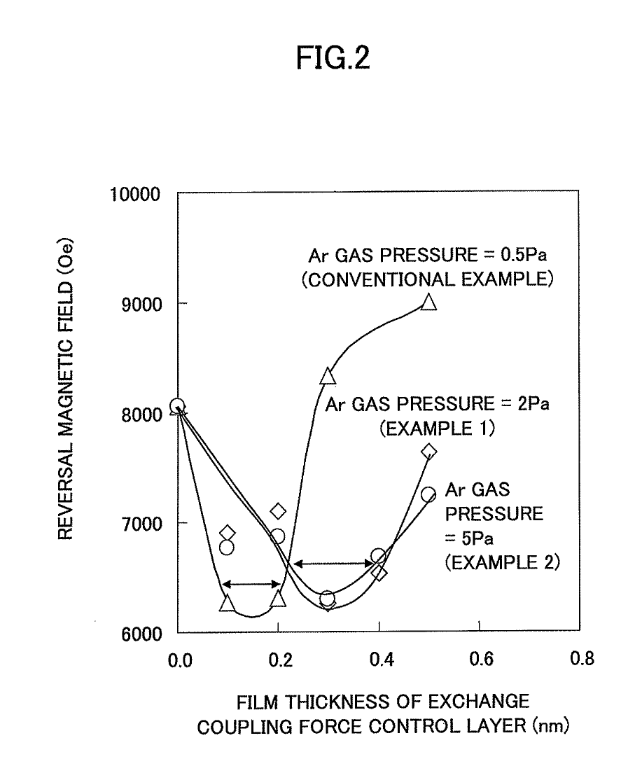

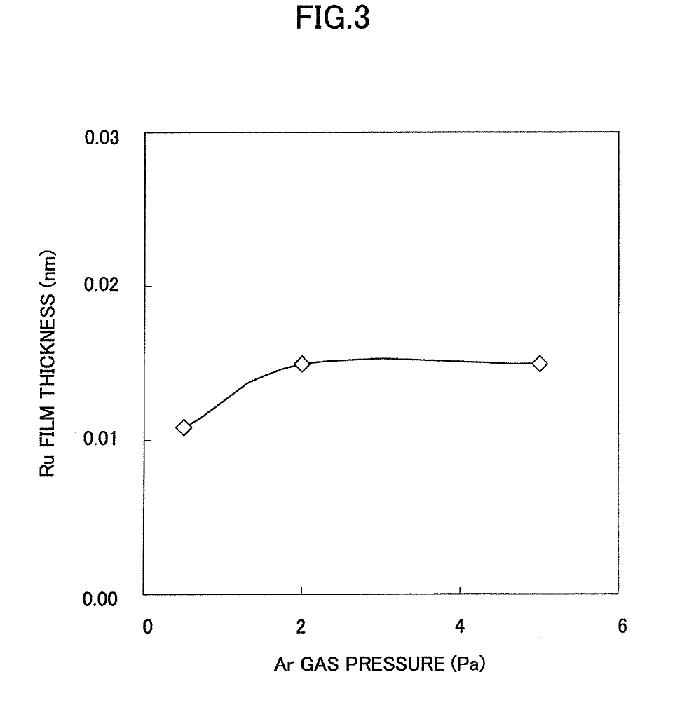

Next, advantages of the perpendicular magnetic recording medium 10 of the embodiment of the present invention are discussed with reference to FIG. 2 and FIG. 3.

FIG. 2 is a graph showing a reduction effect of a reversal magnetic field when the thickness of the exchange coupling force control layer 5 is changed from 0 nm to 0.6 nm. In the graph shown in FIG. 2, the vertical axis indicates the strength of the reversal magnetic field and the horizontal axis indicates the thickness of the exchange coupling force control layer 5.

In the graph shown in FIG. 2, an example 1 is a case where the perpendicular magnetic recording medium 10 manufactured by the above-discussed method is used. An example 2 is a case where a medium structure and materials the same as the example 1 are used, argon (Ar) is used as the deposition process gas for the exchange coupling force control layer 5, and the different deposition gas pressure of 5 Pa is used. In addition, a conventional example is a case where a medium structure and materials the same as the example 1 are used, argon (Ar) is used as the deposition process gas for the exchange coupling force control layer 5, and the 0.5 Pa normal deposition process gas pressure is used.

As shown in FIG. 2, in the conventional example, the proper film thickness whereby the reversal magnetic field is reduced is approximately 0.15 nm. However, as discussed above, when the proper film of the exchange coupling force control layer is extremely thin like the conventional example, there is a problem of producability of the perpendicular magnetic recording medium.

On the other hand, the proper film thickness in the example 1 and the example 2 are increased so as to be approximately twice as that of the conventional example. Thus, according to the perpendicular magnetic recording medium 10 of the embodiment of the present invention, it is possible to improve the producability. In addition, even if the process gas pressure is 5 Pa like example 2, the change of the film thickness of the exchange coupling force control layer 5 is not so different from that of example 1. Accordingly, it is possible to realize the exchange coupling force control layer 5 having a high film thickness (0.3 nm) and high producability at least if the process gas pressure is equal to or greater than 2 Pa and equal to or less than 5 pa.

FIG. 3 is a graph showing a relationship between argon (Ar) gas pressure and ruthenium (Ru) film thickness margin. Here, the ruthenium (Ru) film thickness margin means the film thickness of the Ru layer in a scatter of 2000e because the reversal magnetic field is rough. As shown in FIG. 3, it can be confirmed that the Ru layer film thickness margin can be expanded to approximately 1.5 by increasing the Ar gas pressure from approximately 0.5 Pa to approximately 2.5 Pa. Therefore, through the result shown in FIG. 3, it can be confirmed that the producability of the perpendicular magnetic recording medium 10 can be improved.

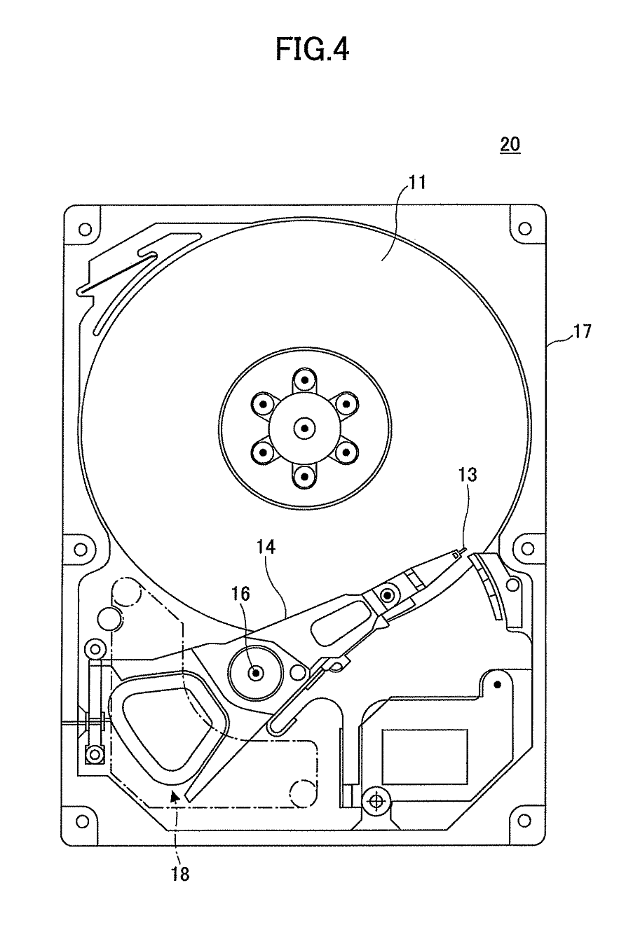

Next, a magnetic recording and reproducing apparatus 20 having the magnetic recording medium 10 of the embodiment of the present invention is discussed with reference to FIG. 4. FIG. 4 is a plan view of the magnetic recording and reproducing apparatus 20 of the embodiment of the present invention. The magnetic recording and reproducing apparatus 20 is a hard disk apparatus installed in a personal computer, as a recorder of a television set, or the like.

In the magnetic recording and reproducing apparatus 20, the magnetic recording medium 10 as a hard disk is mounted in a housing 17. The magnetic recording medium 10 can be rotated by a spindle motor or the like. In addition, a carriage arm 14 is provided inside the housing 17. The carriage arm 14 can be rotated with respect to a shaft 16 by a voice coil motor (VCM) 18. The magnetic head 13 is provided at a head end of the carriage arm 14. The magnetic head 13 scans above the magnetic recording medium 19 so that magnetic information is written in or read from the magnetic recording medium 10.

There is no limitation of the kind of the magnetic head 13. The magnetic head may be formed by a magnetic resistance element such as Giant Magneto-Resistive (GMR) element or Tunneling Magneto-Resistive (TuMR) element. In addition, the magnetic recording and reproducing apparatus is not limited to the above-discussed hard disk apparatus. The magnetic recording and reproducing apparatus 20 may be an apparatus configure to record the magnetic information on a flexible tape magnetic recording medium.

Thus, according to the embodiments of the present invention, even if the exchange coupling force control layer is formed thick, it is possible to keep the exchange coupling energy of the recording layer high. Therefore, it is possible to improve the perpendicular magnetic recording properties and producability of the magnetic recording media.

All examples and conditional language recited herein are intended for pedagogical purposes to aid the reader in understanding the principles of the invention and the concepts contributed by the inventor to furthering the art, and are to be construed as being without limitation to such specifically recited examples and conditions; nor does the organization of such examples in the specification relate to a showing of the superiority or inferiority of the invention. Although the embodiment of the present invention has been described in detail, it should be understood that various changes, substitutions, and alterations could be made hereto without departing from the spirit and scope of the invention.

This patent application is based on Japanese Priority Patent Application No. 2008-80738 filed on Mar. 26, 2008, the entire contents of which are hereby incorporated herein by reference.

What is claimed is:

1. A manufacturing method of a magnetic recording medium, comprising:
a step of stacking a soft magnetic backing layer, an intermediate layer, a first recording layer having a perpendicular magnetic anisotropy, an exchange coupling force control layer including ruthenium, and a second recording layer having a perpendicular magnetic anisotropy on a substrate in order,
wherein a gas pressure of a process gas when the exchange coupling force control layer is being formed is higher than the gas pressure of the process gas when being normally used.

2. The manufacturing method of the magnetic recording medium as claimed in claim 1,
wherein only ruthenium is stacked as the exchange coupling force control layer.

3. A manufacturing method of a magnetic recording medium, comprising:
a step of stacking a soft magnetic backing layer, an intermediate layer, a first recording layer having a perpendicular magnetic anisotropy, an exchange coupling force control layer including ruthenium, and a second recording layer having a perpendicular magnetic anisotropy on a non-magnetic substrate in order,
wherein a gas pressure of a process gas when the exchange coupling force control layer is being formed is equal to or greater than 2 Pa and equal to or less than 5 Pa.

4. A magnetic recording medium, comprising:
a substrate;
a soft magnetic backing layer formed on the substrate;
an intermediate layer formed on the soft magnetic backing layer;
a first recording layer having a perpendicular magnetic anisotropy, the first recording layer being formed on the intermediate layer;
an exchange coupling force control layer formed on the first recording layer, the exchange coupling force control layer including ruthenium, the exchange coupling force control layer having a film thickness equal to or greater than 0.2 nm and equal to or less than 0.4 nm; and
a second recording layer formed on the exchange coupling force control layer, the second recording layer having a perpendicular magnetic anisotropy, the second recording layer ferromagnetically coupled to the first recording layer via the exchange coupling force control layer.

5. The magnetic recording medium as claimed in claim 4,
wherein the ruthenium forming the exchange coupling force control layer has a particle structure.

6. The magnetic recording medium as claimed in claim 4,
wherein the exchange coupling force control layer is made of only the ruthenium.

7. The magnetic recording medium as claimed in claim 5,
wherein the second recording layer formed on the exchange coupling force control layer has a particle structure.

8. A magnetic recording apparatus, comprising:
the magnetic recording medium as claimed in claim 4; and
a magnetic head facing the magnetic recording medium.
